(19) United States
(12) Patent Application Publication
(10) Pub. No.: US 2013/0009401 A1
(43) Pub. Date: Jan. 10, 2013

(54) OFFSHORE HYDRO POWER STATION

(76) Inventor: Alexey BITERYAKOV, Moscow (RU)

(21) Appl. No.: 13/179,071

(22) Filed: Jul. 8, 2011

(51) Int. Cl. F03B 13/20; H02K 15/00

(52) U.S. Cl. 290/53; 29/596

(57) ABSTRACT

A system and a method of electric power generation utilizing sea wave energy is disclosed. The invention consists of an underwater system where seawater flows through an underwater turbine which generates electric power. The waste water that passes through the turbine then flows into underwater tanks on the seabed. According to the invention, simultaneously, water is pumped out of the underwater tanks to the surface by mechanical devices located at the surface utilizing wave motion.

### BACKGROUND OF THE INVENTION

The present invention relates to the field of renewable energy, specifically to a method and system that produces electric power utilizing sea energy.

### DESCRIPTION OF THE PRIOR ART

There has been much research and practical attempts to utilize marine energy resources. Wave power devices are generally categorized by the method used to capture the energy of the waves. The main types are: point absorbers or buoys; surface following devices or attenuators oriented parallel to the direction of wave propagation; terminators, oriented perpendicular to the direction of wave propagation; oscillating water columns; and overtopping devices.

Existing technologies face serious challenges harming the cost-effectiveness. Among the challenges are included the following. The wave powered device has to efficiently convert wave motion into electricity. Generally speaking, wave power is available at low speed and high force, and the motion of forces is not in a single direction. Furthermore the potential impact on the marine environment is a concern. All this requires special engineering solutions to harness wave energy, leads to higher costs of the projects and badly affects the competitiveness of wave power generation.

Instead of wave powered devices, others have used submerged power generators.

US 2009/0302613 publication of Ullman discloses a method for generating power, having a step-by-step process of: (a) submerging a housing into a body of water, the housing defining a chamber therein; (b) maintaining the chamber at a pressure lower than the pressure exerted by the body of water on the housing; (c) admitting water from the body of water into the chamber and driving a turbine with the water flowing into the chamber to generate electric power; (d) discharging water from the chamber into the body of water; and (e) sequentially repeating steps (c) and (d).

The system described therein which performs this method requires a compressed gas source to discharge the waste water from the chamber. This requires additional energy input and furthermore leaves residue of discharge gas in the sea, which could be potentially harmful to marine environment.

U.S. Pat. No. 4,092,828 issued to Garza discloses a hydroelectric plant positioned on the bottom of the ocean floor and extending well above the ocean surface. A chamber on the ocean floor has openings that allow ocean water to be fed through channels to drive a turbine which in turn drives a generator to create power. The water that drives the turbine falls to a lower chamber. A piston adjacent to this lower chamber moves up and down in a hydraulic cylinder and discharges the used ocean water back into the ocean adjacent to the chamber on the ocean floor. The movement of the piston is controlled by a float at the ocean surface.

This float control system requires a complex set of lever arms and electronic controls at the surface to control the discharge piston. The entire structure also has a large expanse above the ocean surface which may have an environmental impact.

U.S. Pat. No. 7,188,471 issued to Walters discloses a submerged power plant chamber resting on the sea bed. The chamber has an intake valve for admitting high pressure water from the surrounding sea into the chamber. The incoming sea water rotates a turbine within the chamber and generates electricity. The sea water falls to the bottom of the chamber. A piston in the bottom of the chamber is moved up and down by a buoy on the sea surface and forces the sea water from the bottom of the chamber back into the sea.

GB Pub 2,428,071 of Shepherd discloses a hydroelectric power plant chamber positioned below the surface of a body of water. Water entering the chamber via ducts drives a turbine that generates electricity. The waste water passing through the turbine is then fed into waste tanks. Compressed air is then injected into these tanks and the waste water is forced back into the body of water.

None of the above references disclose the use of suction pumps at the surface of a body of water controlled by a buoy at the surface to remove water from their underwater chambers.

Also, none of the references disclose the ease of assembly and disassembly of their apparatus that permits both expansion or reduction of their facilities.

The present invention not only has the above capabilities, and uses no gas, as did two of the above references, and also has only one moving part below the sea namely a turbine. The latter capability means less maintenance problems than the prior art.

### BRIEF SUMMARY OF THE INVENTION

It is an object of the invention to improve wave power generation cost-efficiency and reduce the cost of power produced.

The invention advantageously provides a method and apparatus for generating power, which includes simultaneous processes of: (a) admitting water into underwater tanks, and driving a turbine with the water flowing into the tanks to generate electric power; and (b) discharging water from the underwater tanks to the surface of the body of water.

The invention advantageously provides a system of interconnected underwater tanks that provide the ability to use many buoy activated pumps associated with these tanks to harvest wave energy on a large area using only one or several large turbines.

The invention advantageously provides mechanical devices to discharge the water from the tanks.

The invention provides the following advantages: there is no need to build large structures some extending above the water surface or to use compressed air or gas as required by some prior art; it is possible and economically feasible to increase the capacity of the apparatus by adding onto the apparatus tank-by-tank; it is relatively easy and inexpensive to remove tanks or deconstruct the apparatus; there is no need to halt the operation of all the systems if a leakage or other technical problem occurs, or for regular maintenance.

The invention, when compared to the prior art, requires less hardware.

A power generation station, according to the invention has the following key elements: one or many interconnected underwater water-accumulating tanks; one or many turbines and generators; air conduits communicating the tanks with the atmosphere for pressure control in the tanks; and the pumps discharging the wastewater out of the tanks to the surface utilizing wave motion. Electricity generated is transmitted ashore by power lines.

A key part of the proposed construction is the system of hollow interconnected tanks, each interconnected to one another on the seabed. This system is located on a large area of the seabed or above the seabed, but below the water surface. The tanks have air conduits communicating the tanks with the atmosphere for pressure control in the tanks. The water from the sea is admitted into the tanks. The energy of the water coming into the tanks is used to produce electric power. The water is distributed among all interconnected tanks. According to the invention, simultaneously other key processes are being executed. In particular, the waste water in the tanks is being lifted onto the sea surface by piston or diaphragm pumps at the surface utilizing wave motion. Discharging the water out of the tanks frees the space for new volumes of incoming water, while simultaneously generating electric power, which will be described in detail hereinafter.

The apparatus and the method described above tackles major challenges of wave power generation, because it ensures the unbroken, regulated, and always one direction water flow coming through the turbine until the tanks are full.

Discharging the water out of the tanks utilizing the energy of waves becomes the main task and the challenge.

### BRIEF DESCRIPTION OF THE DRAWINGS

The invention will be better understood and further objects and advantages thereof will become more apparent from the ensuing detailed description of preferred embodiments taken in conjunction with the drawings, in which:

FIG. 1 shows a turbine tank, a number of interconnected water collection tanks and surface suction pumps for evacuating the water from the tanks;

FIG. 2 shows an example of arranging a tank farm on the seabed connected to the turbine tank;

FIG. 3 shows a buoy with a piston pump in upward and downward positions;

FIG. 4 shows another modification of a buoy with a piston pump in upward and downward positions;

FIG. 5 depicts a buoy with a surface diaphragm pump with the diaphragm in upward and downward positions;

FIG. 6 shows a buoy with a piston pump where the buoy is going up and down on inclined runners with the buoy in upward and downward positions;

FIG. 7 depicts a buoy with a diaphragm pump using a plate to catch wave motions and showing the plate in upward and downward positions.

### DESCRIPTION OF THE PREFERRED EMBODIMENT

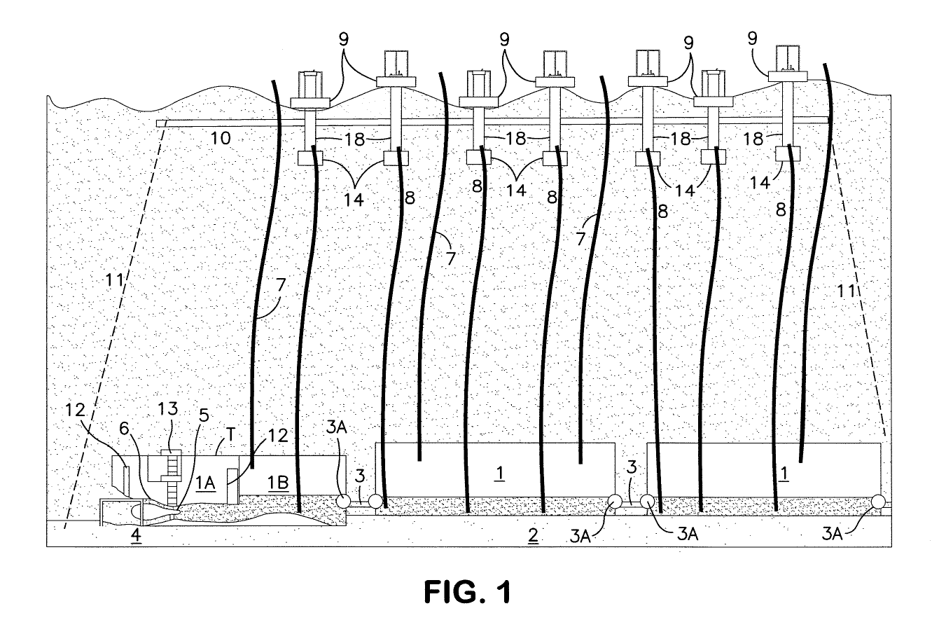

FIG. 1 shows a first embodiment which uses suction pumps to evacuate the water from underwater tanks 1, to generate electricity. The tanks can take a number of different shapes. The shapes shown are merely for illustration. Massive turbine tank T and water-accumulating tanks 1 are based on a large area of the seabed or another stable underwater structure 2. The tanks are connected to each other via connection pipes 3 so that the water coming into the first tank is distributed among all interconnected tanks. At any given time the water level in each tank is virtually the same, due to the interconnection of the tanks via pipes 3. Stopcocks 3A are positioned at the entrance and exit points of each tank to seal the tanks if needed.

As shown in FIG. 1, the first tank T is divided into two areas 1A and 1B. The area 1A houses the turbine 5 and generator 6 and has a system of doors and ladders 13 that allow human access into the turbine/generator area 1A. Area 1A also has a pair of gates 12, one gate 12 seals the front entrance into the turbine chamber at channel 4 and the second gate 12 seals the turbine/generator area 1A from the water collection area 1B of the first tank.

The tanks 1 are sealed such that the only way the water can come into the tank system is through a channel 4 at the entrance to turbine tank T. Water coming in through the channel 4 causes the rotation of a turbine 5. The turbine is connected to a generator 6, enabling the hydraulic energy of water to be converted into rotational mechanical energy by the turbine 5, and the mechanical energy to be converted into electrical energy. Furthermore, the water coming into the first tank is being distributed among all the interconnected tanks 1 via the water collection area 1B at the rear of the turbine tank T. As the water becomes accumulated in the tanks T and 1 the water pushes the air out of the tanks T and 1 through air conduits 7 positioned in the tanks and positioned above at sea level by binding joists 10. The energy of the air being discharged through the conduits can be utilized as well, i.e. converted into electrical energy.

Understandably, the underwater tank system can be installed in different sizes and shapes. The size of an installation can vary from one or several tanks to massive concrete structures that can be parts of an artificial island. It is also possible to use natural caverns or hollow structures as water-accumulating tanks.

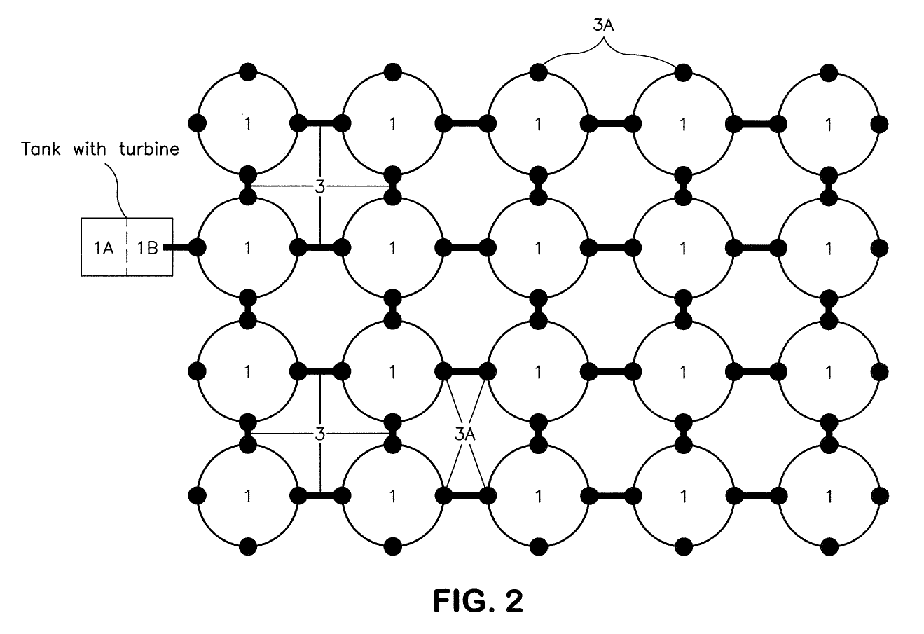

Note that FIG. 2 shows an example of arranging tanks 1 into a tank farm on a seabed 2 and connecting it to the output of the water collection area 1B of the turbine tank T. As shown, the tanks 1 on the outer sides of this tank farm have stopcocks 3A that remain unconnected to another tank. If expansion of the tank farm is desired, additional tanks could easily be added to these unconnected stopcocks 3A without disrupting the operation of the other tanks. This arrangement also indicates that the entire tank farm system could easily be completely dismantled and moved to a different location.

The pumps are located near sea surface in pump housings 18 which are mounted to the binding joists 10. Pump housings 18 together with additional ballast 14 and binding joists 10 allow keeping the pumps in the upright position. The group of the binding joists 10 is moored to the tanks 1 or another underwater structure by steel ropes 11, or in other suitable manners. In operation, air conduits 7 are mounted in one or more of the tanks 1B and 1 to keep them at atmospheric pressure and are extended above the sea surface and mounted to binding joist 10. Water pipes 8 are positioned in one or more of the tanks T and 1 and are extended above to connect to the pumps mounted in the pump housings 18. The pumps are operated by buoys 9 which have movements following wave motions.

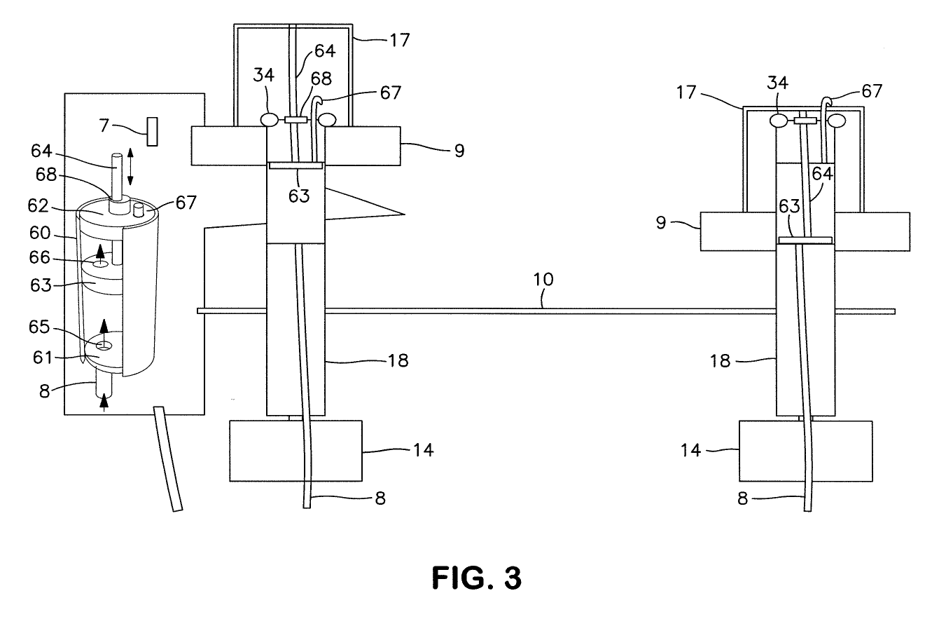

FIG. 3 illustrates the operation of the pumps being used in the FIG. 1 embodiment. As shown in the left side of this figure, as the buoy 9 rises the buoy/piston rod connector 17 rises causing the piston 63 to rise. Stops 34 on the top of the pump housing 18 stop the buoy 9 from rising higher. As can be seen in the pump enlargement of FIG. 3, the pump has a cylindrical housing 60 closed at the top and bottom by top plate 62 and bottom plate 61. The bottom plate 61 has a valve 65 that opens to allow water coming from the tanks 1B and 1 via pipe 8 to enter the cylinder 60 when piston 63 is pulled up by piston rod 64 that passes through a rubber opening 68 in the top plate 62 and connects to the buoy/piston rod connector 17. As the piston 63 rises valve 66 of the piston is closed and water is expelled from the pump though outlet pipe 67. When the buoy 9 falls as seen in the right illustration, valve 66 in the piston 63 opens and valve 65 in the bottom plate 61 closes. The water below the piston will pass through open valve 66 of the piston. When the piston 63 rises again valve 66 will close and the rising piston will expel the water above the piston and new water will enter the cylinder through open valve 65.

There are also many different modifications, not shown in the drawings. Among them are using different types of the pumps, to be described hereinafter, maintaining higher or lower pressure in the tanks, and other modifications, subject to engineering solutions.

According to the invention, a number of subtypes of positive displacement pumps can be used.

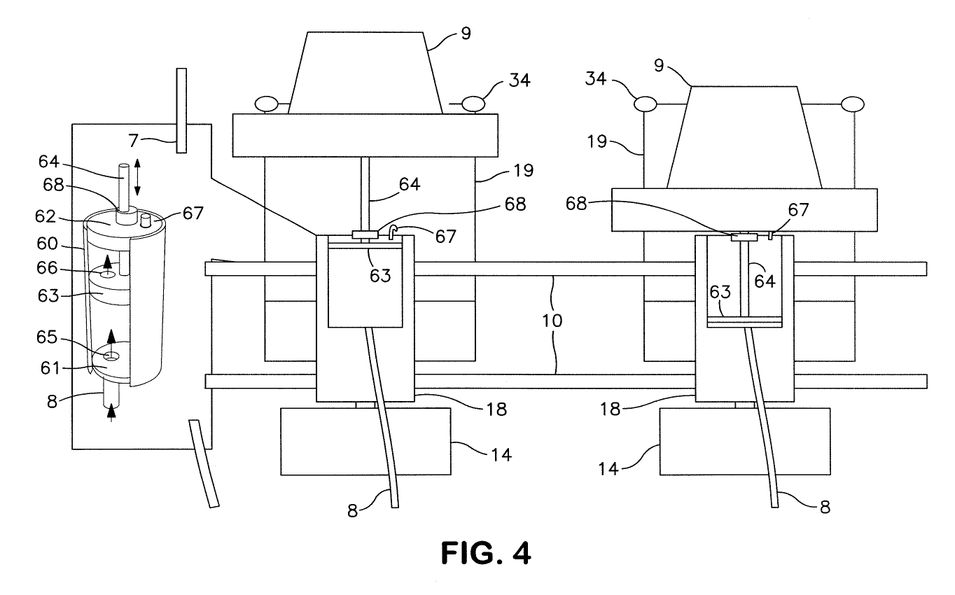

FIG. 4. discloses an alternate version of the pump used in FIG. 3. The pump per se is the same pump used in the FIG. 3 embodiment. FIG. 4 differs in that instead of the buoy 9 riding up and down on the outside of the pump cylinder housing as in FIG. 3, the buoy 9 slides up and down on a running guide 19 which is mounted on binding joists 10. The pump piston rod 64 is attached to the bottom of the buoy 9 so that the piston 63 rises and falls as the buoy 9 rises and falls. The enlarged pump structure shown on the left of the figure is the same as the one shown in FIG. 3.

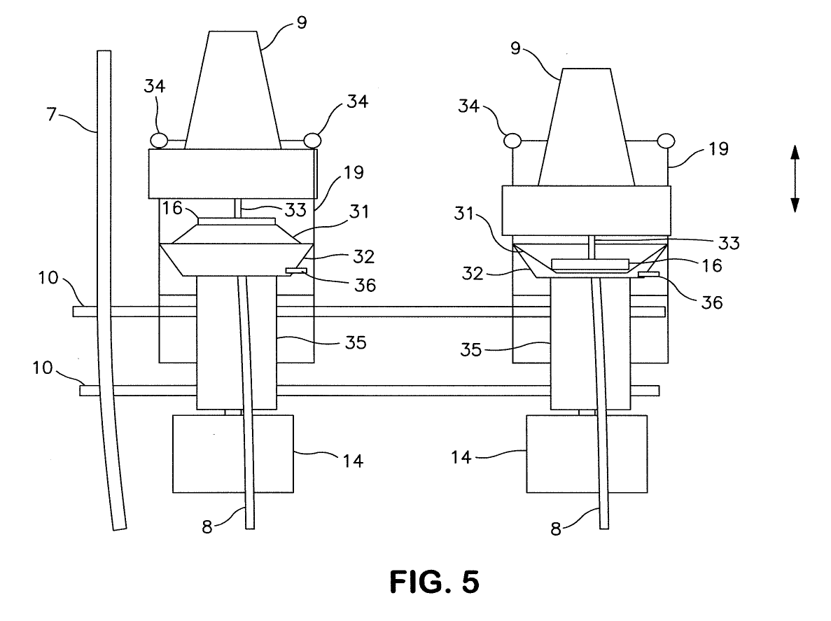

FIG. 5 depicts a surface diaphragm pump showing a diaphragm 31 in an upward and downward position. The main parts of a diaphragm pump include the diaphragm 31, a piston 16 moving the diaphragm 31, a chamber 32, flexible but strong enough water pipes 8 connected to the turbine tank T or tanks 1 (see FIG. 1), an inlet valve not shown, an outlet valve 36, a body 35 of the pump which together with additional ballast 14 and binding joists 10 allow keeping the pump in the upright position, a buoy 9 which goes up and down on the waves, a system of runners 19 having stop points 34 allowing the buoy to move strictly up and down on a limited distance of the runners. The buoy 9 is connected to the piston 16 securely by means of steel bars 33.

When a wave rises up the buoy 9 rises with the wave which causes via the connection of the steel bars 33 the piston 16 to be pulled up, and consequently the diaphragm 31 expands upward, the volume of the chamber increases, the pressure decreases, and water is drawn into the chamber via an inlet valve not shown. Later, when the wave goes down, the diaphragm 31 deflates downward, for example, under the weight of the buoy 9 and the water is pushed out of the chamber 32 through the outlet valve 36.

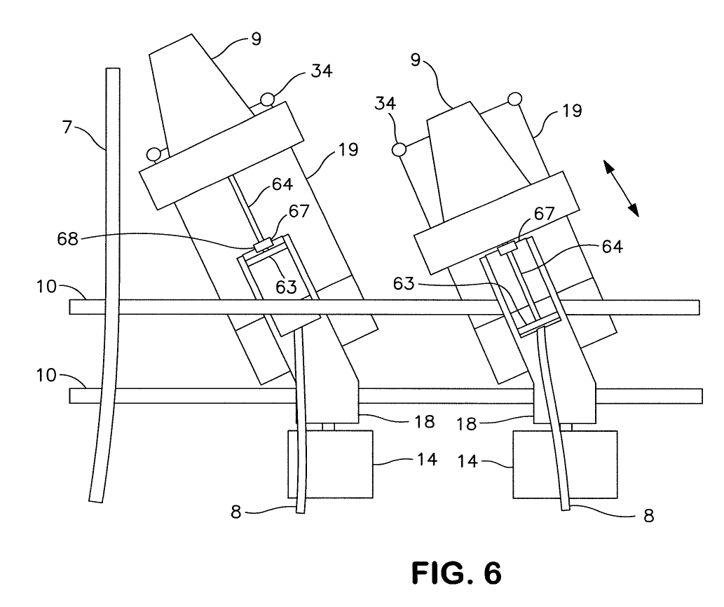

Additionally, the buoy movement direction can be varied as an option. FIG. 6 depicts such a buoy 9 having its movement directed by inclined runners 19. This system works essentially the same as the pump described with reference to FIG. 3 or 4, and similar elements have been labeled accordingly. The buoy 9 can move vertically or along an inclined line, as indicated by the arrow. This option can be useful depending on the wave characteristics in a certain place.

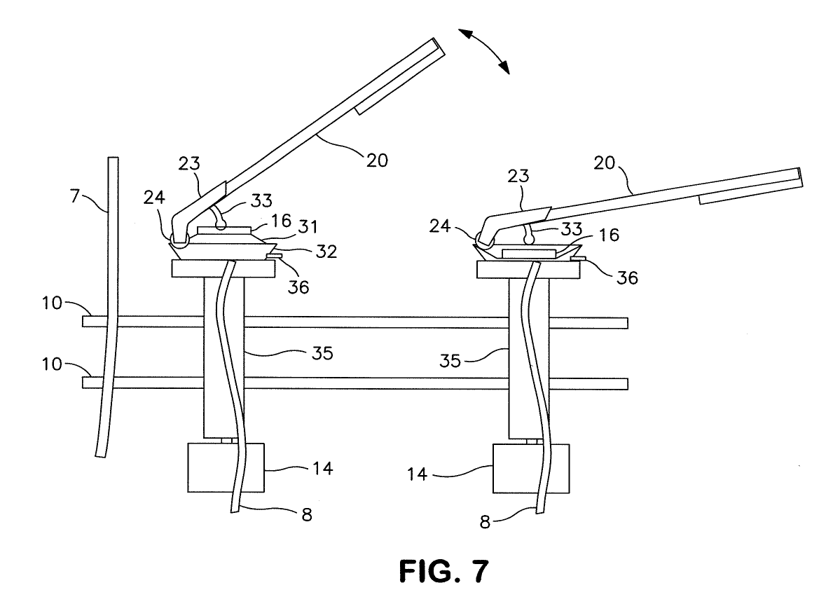

Additionally, the buoy form can be varied as an option, wherein a body taking wave motion can be not only a buoy, but it can have different shapes as well. FIG. 7 shows a varied buoy form using an alternative plate 20 to catch wave motions, and a diaphragm pump 31-32 for pumping the water. In this option, the plate 20 goes up and to the left in the drawing when a wave hits it, and returns to its initial position when at the bottom of a wave, as indicated by the arrow. To enable this motion by the plate, the plate 20 is mounted on a pivoting arm 23 by means of a bearing 24 mounted to the body of the diaphragm pump. As the plate 20 moves up, the piston 16 coupled to pivoting arm 23 by element 33 expands the diaphragm 31 thereby drawing water into the chamber 32 of the pump. As the plate 20 moves down, the piston 16 connected to the pivoting arm 23 by element 33 compresses the diaphragm 31 and expels the water from the pump at outlet 36.

Although the plate 20 described above is used with a diaphragm pump, a piston pump could also be used with the plate being attached to an angled piston pump to move the piston up and down.

Many other options of lifting the water with surface positive displacement pumps are possible.

The tanks can be submerged in the water only in part. In this case the top of the tanks is not needed, but maintaining a difference between sea level and water level in the tanks is essential. Taking into consideration that the tanks can exist in different size, it is possible to build a dam in the sea around a certain area, and use the inner area as a top-free tank. Suction pumps will be placed around the dam in this case.

There are many ways to assemble the offshore hydro power station shown in FIG. 1.

According to one way, the first most challenging step is to install the turbine tank T which has two sections 1A and 1B as shown in FIG. 1. Section 1A contains the turbine and generator and section 1B is the initial water collection area of the power station. The latter section can be much larger than shown. This turbine tank is fully assembled on shore. The first section 1A includes a turbine 5, a generator 6 connected to the turbine 5, a system of doors and ladders 13 allowing human access into the turbine tank, and a pair of gates 12. The first gate 12 seals the entrance to the turbine from the sea and the second gate 12 seals the initial water collection area 1B from section 1A. It is possible during this on shore assembly to assemble the water pumps consisting of a pump housing 18, a buoy 9, and a ballast 14, and to connect the water pipe 8 at one end to the water pump and the other end to the initial water collection area 1B of the turbine tank. An air conduit 7 is also connected at one end to the initial water collection area 1B and at the other end to the buoy 9. Although in FIG. 1 only a single pump is shown connected to the initial water collection area 1B, more could be added since collection area 1B could be much larger. The assembled tank with its attached pump, buoy, ballast and water and air pipes is then pulled by ship to the desired location. Water is then pumped into the tank to make the tank sink. Cranes and other devices can be used to ensure undistorted sinking. As the tank sinks, the pumps, the buoys, the ballasts and top parts of the water and air pipes will stay near the water surface and will become vertical. It is relatively easy to move the tank and correct its trajectory until it is on the sea bed 2. Pressure is high and the buoyant force is low because the tank is on the sea bed. Nevertheless, it is possible to moor the tank more securely using personnel below the sea.

The second step is to assemble the water tanks 1. Just as the turbine tank T, the water tanks 1 are assembled on shore. The water pipes 8, buoys 9, pump housings 18, ballasts 14 and air conduits 7 are all preassembled to the tanks 1 onshore. It is also possible to assemble a set of interconnected tanks 1 on shore by adding water pipe couplings 3 and stopcocks between the tanks 1. These pipe couplings 3 connect with stopcocks 3A on the adjacent tanks 1. These assembled tanks are then pulled by ship to the desired location. When on location, water is added to the tanks to sink them. As the tanks sink, the pumps, the buoys, the ballasts and top parts of the water pipes and air pipes stay near the surface and become vertical. As with the turbine tank, cranes and other devices can be used to ensure undistorted sinking. It is relatively easy to move the tanks and correct the trajectory until the tanks are on the seabed. Pressure is high and the buoyant force is low because the tanks are on the seabed. Nevertheless, it is possible to moor the tanks. Temporary binding joist can be used to avoid splicing the pipes. They are easy to add and easy to remove by just putting them on the buoys.

The third and final steps are done by diver teams in this stage. However, it is not very difficult work because the depth is not high due to atmospheric pressure limitations for suction pumps.

First, everything on the seabed should be done. The diver teams connect all unconnected tanks 1 and open all stopcocks 3A among the tanks. A pipe coupling 3 connects one or more of the tanks 1 to the water collection area 1B of the turbine tank.

All outer gates 12 and outer stopcocks 3A remain closed. So the tanks 1 are filled with water, but sealed from the ocean.

Next work is done near the surface. As shown in FIG. 1, all the buoys 9 should be tightened with binding joists 10 so that they are on the same level. The top part of the bodies must always be above sea level. The water pipes 8 and air pipes 7 can be stretched. The binding joist 10 should be moored to the tanks 1 or other structure on the seabed by means of steel ropes 11 or in another suitable manner, to avoid being carried away by waves. The temporary binding joists attached earlier should be removed. The air conduits 7 should be unfastened from the buoys and pinned to the binding joists 10.

Another option for the whole process described above is to pin pump housings 18 and air conduits 7 to the binding joists 10 on shore and complete other steps needed.

The buoys 9 are then unpinned from the pump housing 18 and are allowed to move up and down along the pump housing 18. Water will now be pumped out of the water collection area 1B of the tank T and the tanks 1. At this time the turbine tank is double checked to see that everything is all right and that a power line from on shore is connected to the generator to transmit generated power to shore. All tanks are checked for leaks. The final step is to open the gates 12 of the turbine tank 1A and the system is in operation.

A second way to assemble the power station is to assemble all parts of the power station on shore, including the turbine tank and the attached tanks. The entire assembled power station would then be pulled by ship to the desired location and sunk. As the station is sinking the water pipes upper ends, air conduits upper ends, buoys and joists will remain near sea level.

Maintenance and repairs are an easy process. Also the system can be easily expanded by adding additional tanks 1 to the system.

If it is decided to end the operation, the entire system can be easily dismantled and removed.

The foregoing relates to preferred exemplary embodiments of the invention, it being understood that other variants and embodiments thereof are possible within the spirit and scope of the invention, the latter being defined by the appended claims.

I claim:

1. An apparatus for generating power at an offshore hydro power station, the hydro power station comprising:
an underwater tank located in a body of water;
a turbine located at a water inlet of the tank through which water is admitted into the tank and which converts hydro power into mechanical power;
a generator connected to the turbine for converting mechanical power into electric power; and
at least one wave actuated pump located at the surface of the body of water which removes water from the tank and deposits it at the surface of the body of water, wherein
water is continuously admitted into the underwater tank through the turbine and the turbine is driven with the water flowing into the tank, thereby converting the hydro power of the water into mechanical power;
electric power is continuously generated from the mechanical power by the generator connected to the turbine, and
water is continuously removed from the tank and returned to the surface of the body of water by the at least one wave actuated pump thereby freeing space in the tank for the water continuously being admitted into the tank.

2. The apparatus for generating power at an offshore hydro power station, the hydro power station comprising:
an underwater tank located in a body of water;
a turbine located at a water inlet of the tank through which water is admitted into the tank and which converts hydro power into mechanical power;
a generator connected to the turbine for converting mechanical power into electrical power;
one or more additional underwater tanks interconnected to the turbine tank wherein the water admitted into the turbine tank is simultaneously distributed in a substantially even manner to all additionally interconnected tanks, and
one or more wave activated pumps located at the surface of the body of water connected to one or more of the tanks which pumps remove the water from the tanks and deposits the water at the surface of the body of water, wherein
water is continuously admitted into the underwater tanks though the turbine and the turbine is driven with the water flowing into the tanks, thereby converting the hydro power of the water into mechanical power;
electrical power is continuously generated from the mechanical power by the generator connected to the turbine, and
water is continuously removed from the tanks and returned to the surface of the body of water by the one or more wave activated pumps thereby freeing space in the tanks for the water continuously being admitted into the tanks.

3. The apparatus for generating power according to claim 2, wherein the hydro power station is provided with air conduits connecting the tanks with sea level atmosphere, the air removed from the tanks as water fills the tanks is pushed through the air conduits.

4. The apparatus for generating power according to claim 3, further comprising long distance power lines transmitting the electric power generated at the hydro power station ashore.

5. The apparatus for generating power according to claim 4, wherein the hydro power station is provided with water pipes connecting the tanks and the wave activated pumps at the surface of the body of water, and water being removed from the interconnected tanks by the wave activated pumps and returned to the surface of the body of water is passed through the water pipes.

6. The apparatus for generating power according to claim 5, wherein the wave activated pumps are provided with buoys connected to positive displacement pumps at the surface of the body of water.

7. The apparatus for generating power according to claim 6, wherein the positive displacement pumps are piston pumps whose pistons are coupled to the buoys, and wherein the buoys are constrained to move vertically wherein the wave motion moving the buoys up and down moves the pistons up and down to draw water from the tanks and deposit it at the surface of the body of water.

8. The apparatus for generating power according to claim 6, wherein the positive displacement pumps are diaphragm pumps whose pistons are coupled to the buoys, and wherein the buoys are constrained to move vertically wherein the wave motion moving the buoys up and down moves the diaphragm up and down to draw water from the tanks and deposit it at the surface of the body of water.

9. The apparatus according to claim 6, wherein the buoys are plate buoys that rotate about an axis when hit by a wave and wherein the positive displacement pumps are piston or diaphragm pumps whose pistons are coupled to the plate buoys wherein the wave motion moving the plate buoys moves the pistons up and down to draw water from the tanks and deposit it at the surface of the body of water.

10. The apparatus for generating power according to claim 6, wherein the positive displacement pumps are piston pumps whose pistons are coupled to the buoys and wherein the buoys are constrained to move in a direction inclined to the vertical, wherein the wave motion moving the buoys in a direction inclined to the vertical moves the pistons in a direction inclined to the vertical to draw water from the tanks and deposit it at the surface of the body of water.

11. The apparatus according to claim 6, wherein the positive displacement pumps are diaphragm pumps whose pistons are coupled to the buoys and wherein the buoys are constrained to move in a direction inclined to the vertical, wherein the wave motion moving the buoys in a direction inclined to the vertical moves the pistons in a direction inclined to the vertical to draw water from the tanks and deposit it at the surface of the body of water.

12. A method of assembling and operating an underwater hydro power station comprising,
positioning a tank containing a turbine, a generator connected to the turbine and a water collection area, below the surface of a body of water, the water collection area of the tank initially being sealed from the area of the tank containing the turbine and generator,
maintaining the water collection area of the tank at atmospheric pressure using an air conduit,
positioning one or more wave activated pumps at the surface of the body of water and fluidly connecting them by water pipes to the water collection area of the tank,
fastening together and grouping the one or more wave activated pumps and the air conduit with a binding joist and mooring the joist to the tanks or other seabed structure and
opening the seal between the water collection area of the tank and the turbine and generator thereby allowing water to flow serially from the body of water through the turbine and into the water collection area of the tank, the turbine rotation causing the generator to generate electrical power,
continuously pumping the water entering the water collection area of the tank to the surface of the body of water by means of the one or more wave activated pumps fluidly connected by water pipes to the water collection area of the tank, and
transmitting the generated electrical power ashore.

13. The method of claim 12 further comprising,
initially assembling on shore the tank containing the turbine, the generator and the water collection area and connecting the one or more wave activated pumps, the air conduit, the binding joist and water pipes to the water collection area of the tank,
towing these components to sea, and
sinking the turbine tank at a selected location and allowing the wave activated pumps and the air conduit and water pipes to the turbine tank to remain at the sea surface.

14. The method of claim 12 further comprising,
connecting one or more interconnected water collection tanks to the water collection area of the turbine tank so that water entering the water collection area of the turbine tank will flow continuously and uniformly to all the interconnected water collection tanks,
maintaining the water collection tanks at atmospheric pressure using air conduits,
positioning one or more wave activated pumps at the surface of the body of water and fluidly connecting them by water pipes to the one or more water collection tanks,
fastening together and grouping the one or more wave activated pumps and the air conduits with binding joists and mooring the joists to the tanks or other seabed structure and
continuously pumping the water entering the water collection tanks to the surface of the body of water by means of the one or more wave activated pumps fluidly connected to the one or more water collection tanks.

15. The method of claim 14 further comprising,
initially assembling on shore the tank containing the turbine, the generator and the water collection area as well as the wave activated pumps and their fluid connections to the water collection area of the tank,
also initially assembling on shore the one or more interconnected water collection tanks as well as the wave activated pumps, their fluid connections and binding joists to the one or more interconnected water collection tanks,
towing these assembled components to sea,
sinking the turbine tank at a selected location and allowing the wave activated pumps and their fluid connections to the turbine tank to remain at the sea surface,
sinking the one or more interconnected water collection tanks at the selected location and allowing the wave activated pumps and their fluid connections to the one or more connected water collection tanks and the binding joists to remain at the sea surface, and
connecting the water collection area of the turbine tank to one or more interconnected water collection tanks.

16. The method of claim 14 further comprising,
initially assembling on shore the tank containing the turbine, the generator and the water collection area as well as the wave activated pumps and their fluid connections to the water collection area of the tank,
also initially assembling on shore the one or more interconnected water collection tanks as well as the wave activated pumps and their fluid connections to the one or more interconnected water collection tanks and the binding joists,
connecting on shore the water collection area of the turbine tank to one of the interconnected water collection tanks,
towing these assembled components to sea, and
sinking the turbine tank and the one or more interconnected water collection tanks at a selected location and allowing the wave activated pumps and their fluid connections to the turbine tank and the one or more interconnected water collection tanks and the binding joists to remain at the sea surface.

17. The method of claim 15 further comprising,
adding one or more additional water collection tanks with their wave activated pumps and their fluid connections to the prior assembled tanks as needed.

18. The method of claim 16 further comprising,
adding one or more additional water collection tanks with their wave activated pumps and their fluid connections to the prior assembled tanks as needed.
